(19) United States
(12) Patent Application Publication
(10) Pub. No.: US 2025/0205601 A1
(43) Pub. Date: Jun. 26, 2025

(54) NON-TRANSITORY COMPUTER-READABLE STORAGE MEDIUM HAVING GAME PROGRAM STORED THEREIN, GAME PROCESSING SYSTEM, GAME PROCESSING APPARATUS, AND GAME PROCESSING METHOD

(71) Applicant: Nintendo Co., Ltd., Kyoto (JP)

(72) Inventors: Makoto MIYANAGA, Kyoto (JP); Tomomi SANO, Kyoto (JP); Satoshi TERADA, Tokyo (JP); Takumi FURUYA, Tokyo (JP); Yuta OKADA, Tokyo (JP)

(21) Appl. No.: 18/799,514

(22) Filed: Aug. 9, 2024

(30) Foreign Application Priority Data
Dec. 22, 2023 (JP) 2023-217124

(51) Int. Cl. A63F 13/56; A63F 13/525

(52) U.S. Cl. CPC A63F 13/56; A63F 13/525

(57) ABSTRACT

A dynamic object is moved in conjunction with a player character in a first state, the player character is moved in conjunction with automatic movement of the dynamic object in a second state, and the first state and the second state are switched based on an operation input.

### CROSS REFERENCE TO RELATED APPLICATION

This application claims priority to Japanese Patent Application No. 2023-217124 filed on Dec. 22, 2023, the entire contents of which are incorporated herein by reference.

### FIELD

The present disclosure relates to information processing for games and the like.

### BACKGROUND AND SUMMARY

Hitherto, there have been games in which a main character supports the movement of a sub-character.

There has been a demand for games that enable game progression with a variety of movement controls.

Therefore, an object of the exemplary embodiment is to provide a non-transitory computer-readable storage medium having a game program stored therein, etc., that enable game progression with a variety of movement controls.

In order to attain the object described above, for example, the following configuration examples are exemplified.

One configuration example is directed to a non-transitory computer-readable storage medium having stored therein instructions that, when executed by a processor of an information processing apparatus, cause the information processing apparatus to: control a player character to move in a virtual space, based on an operation input; automatically control at least one dynamic object placed on a field in the virtual space, based on preset behavior; designate any one of the dynamic objects in response to a first instruction based on an operation input, and while the designation is performed, in a first state, perform a first interlock movement control of moving the designated dynamic object in conjunction with movement of the player character without at least automatic movement of the dynamic object in the behavior, and in a second state, perform a second interlock movement control of moving the player character in conjunction with automatic movement of the designated dynamic object based on the behavior; switch between the first state and the second state in response to a second instruction based on an operation input; and cancel the designation in response to a third instruction based on an operation input.

According to the above configuration example, by moving the dynamic object in conjunction with the movement of the player character or by moving the player character in conjunction with the automatic movement of the dynamic object, various movements can be made, thereby providing a new type of movement control. In addition, since the dynamic object performs the preset behavior even after the designation is cancelled, a high degree of freedom of movement control can be achieved.

In another configuration example, the first interlock movement control may be a control of moving the designated dynamic object to a position where a relative positional relationship between the player character and the designated dynamic object is maintained, and the second interlock movement control may be a control of moving the player character to a position where the relative positional relationship is maintained.

According to the above configuration example, the dynamic object or the player character can be moved to the desired movement destination using movement with the relative positional relationship maintained.

In another configuration example, the instructions may further cause the information processing apparatus to, if a movement destination based on the relative positional relationship of the designated dynamic object in the first interlock movement control or the player character in the second interlock movement control is a position that cannot be entered on the field, update the relative positional relationship without movement to the movement destination.

According to the above configuration example, it is possible to prevent the dynamic object and the player character from entering a location that cannot be entered. In addition, it is possible to provide a play that progresses by adjusting the positional relationship between the dynamic object and the player character.

In another configuration example, the instructions may further cause the information processing apparatus to: in response to a fourth instruction based on an operation input, cause the player character to perform a predetermined action, and cause a simulated object to appear on the field, the simulated object sharing at least part of appearance and the behavior with at least any one type of the dynamic object among a plurality of types of the dynamic objects; and automatically control the simulated object as the dynamic object on the field.

According to the above configuration example, in addition to the dynamic objects placed in advance on the field, various dynamic objects can be caused to appear on the field in various scenes, and the player character can be moved in conjunction with the movement of a dynamic object caused to appear.

In another configuration example, the instructions may further cause the information processing apparatus to: in response to the first instruction, cause the player character to perform an action of emitting an emission object, and if the emission object hits the dynamic object, perform the designation with respect to the dynamic object; and in response to a fifth instruction based on an operation input, change a direction of the player character such that an emission direction of the emission object is toward any one of the dynamic objects on the field.

According to the above configuration example, it becomes easier to cause the emission object to hit the dynamic object.

In another configuration example, the field may include at least a top view field that is a field in a scene where a virtual camera is set to top view, and a side view field that is a field in a scene where the virtual camera is set to side view, the preset behavior for the dynamic object may be behavior in the top view field and the side view field, and the relative positional relationship may be a relative positional relationship in the top view field and the side view field.

According to the above configuration example, the game can be advanced in the scene of the top view field and the scene of the side view field, thus providing various movement patterns based on the relative positional relationship between the dynamic object and the player character.

According to the exemplary embodiment, it is possible to provide a non-transitory computer-readable storage medium having a game program stored therein, etc., that enable game progression with a variety of movement controls.

### BRIEF DESCRIPTION OF THE DRAWINGS

FIG. 1 shows a non-limiting example of a state where a left controller 3 and a right controller 4 are attached to a main body apparatus 2;

FIG. 2 shows a non-limiting example of a state where the left controller 3 and the right controller 4 are detached from the main body apparatus 2;

FIG. 3 is six orthogonal views showing a non-limiting example of the main body apparatus 2;

FIG. 4 is six orthogonal views showing a non-limiting example of the left controller 3;

FIG. 5 is six orthogonal views showing a non-limiting example of the right controller 4;

FIG. 6 is a block diagram showing a non-limiting example of the internal configuration of the main body apparatus 2;

FIG. 7 is a block diagram showing a non-limiting example of the internal configurations of the main body apparatus 2, the left controller 3, and the right controller 4;

FIG. 8 illustrates a non-limiting example of a game screen;

FIG. 9 illustrates a non-limiting example of the game screen;

FIG. 10 illustrates a non-limiting example of the game screen;

FIG. 11 illustrates a non-limiting example of the game screen;

FIG. 12 illustrates a non-limiting example of the game screen;

FIG. 13 illustrates a non-limiting example of the game screen;

FIG. 14 illustrates a non-limiting example of the game screen;

FIG. 15 illustrates a non-limiting example of the game screen;

FIG. 16 illustrates a non-limiting example of the game screen;

FIG. 17 illustrates a non-limiting example of the game screen;

FIG. 18 illustrates a non-limiting example of the game screen;

FIG. 19 shows a non-limiting example of various types of data stored in a DRAM 85;

FIG. 20 is a non-limiting example of a flowchart of game processing; and

FIG. 21 is a non-limiting example of a flowchart of the game processing.

### DETAILED DESCRIPTION OF NON-LIMITING EXAMPLE EMBODIMENTS

Hereinafter, an exemplary embodiment will be described.

### Hardware Configuration of Information Processing System

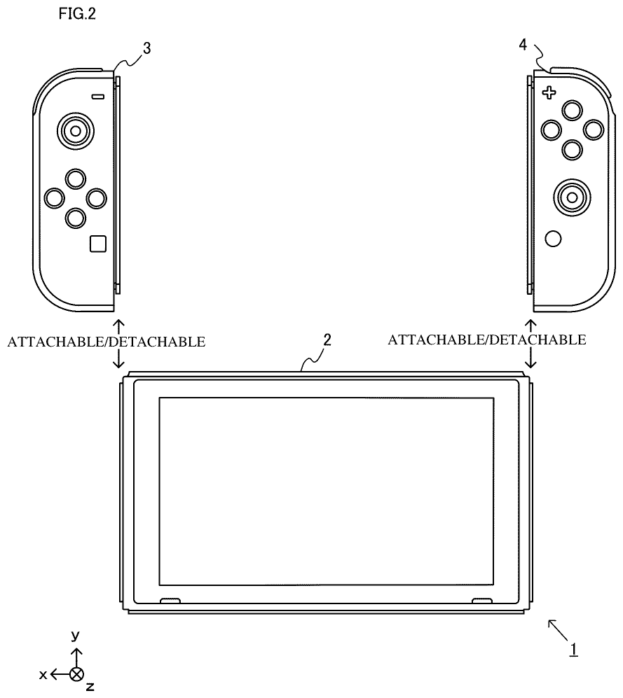

Hereinafter, an information processing system (game system) according to an example of the exemplary embodiment will be described below. An example of a game system 1 according to the exemplary embodiment includes a main body apparatus (an information processing apparatus, which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment will be described, and then, the control of the game system 1 according to the exemplary embodiment will be described.

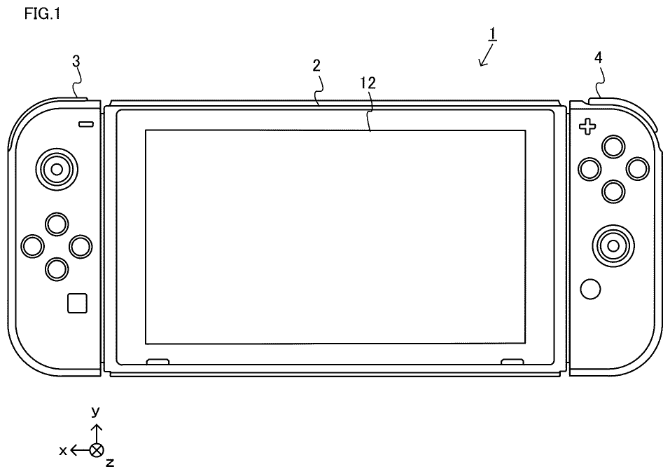

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 shows an example of the state where each of the left controller 3 and the right controller 4 is detached from the main body apparatus 2. As shown in FIGS. 1 and 2, the left controller 3 and the right controller 4 are attachable to and detachable from the main body apparatus 2. Hereinafter, the left controller 3 and the right controller 4 may be collectively referred to as a “controller”.

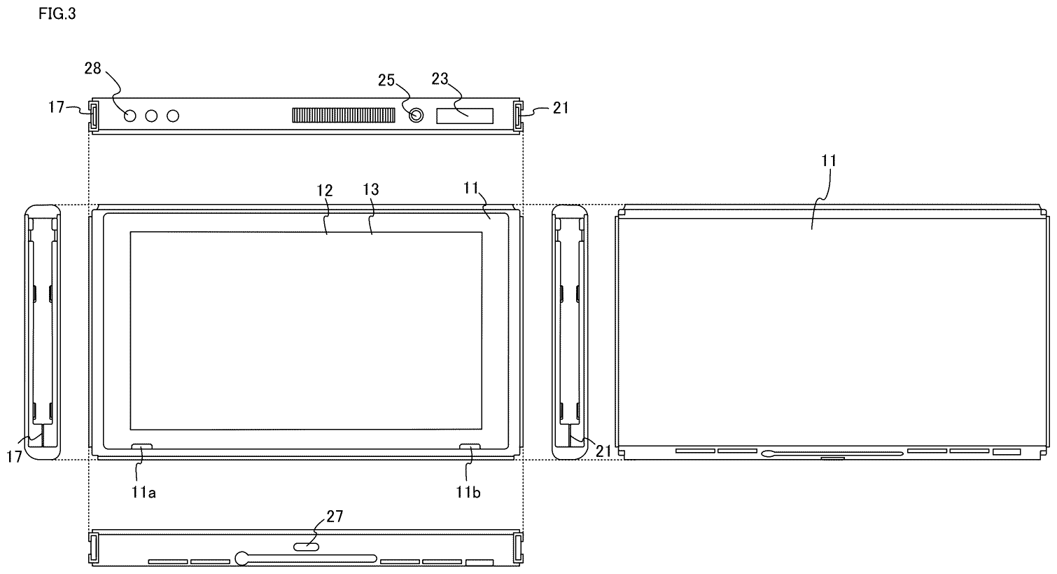

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a substantially rectangular shape.

It should be noted that the shape and the size of the housing 11 are discretionary. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

The main body apparatus 2 includes a touch panel 13 on the screen of the display 12. In the exemplary embodiment, the touch panel 13 is of a type capable of receiving a multi-touch input (e.g., electrical capacitance type). However, the touch panel 13 may be of any type, and may be, for example, of a type capable of receiving a single touch input (e.g., resistive film type).

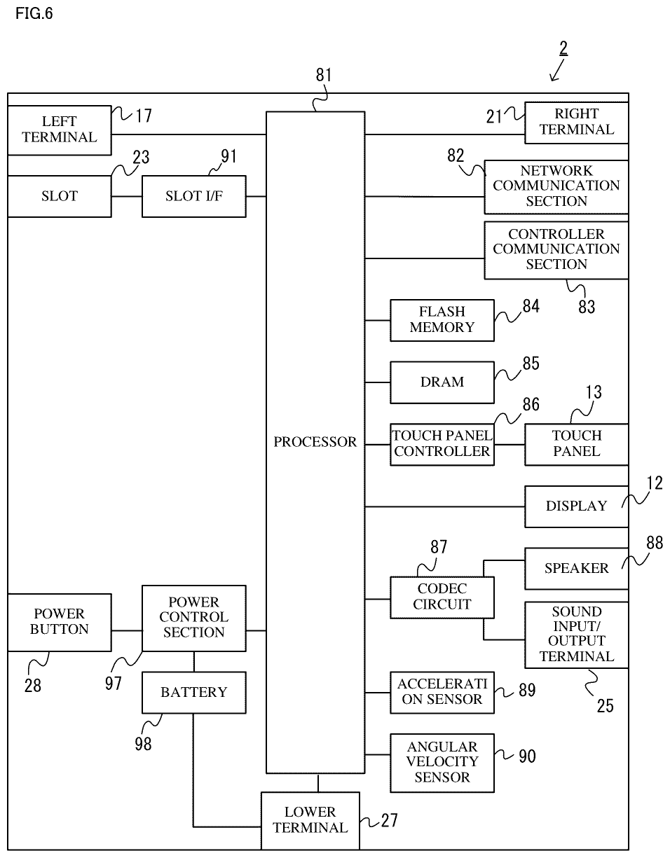

The main body apparatus 2 includes speakers (i.e., speakers 88 shown in FIG. 6) within the housing 11. As shown in FIG. 3, speaker holes 11a and 11b are formed on the main surface of the housing 11. Then, sounds outputted from the speakers 88 are outputted through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). When the unified apparatus or the main body apparatus 2 alone is mounted on the cradle, the game system 1 can display on a stationary monitor an image generated by and outputted from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

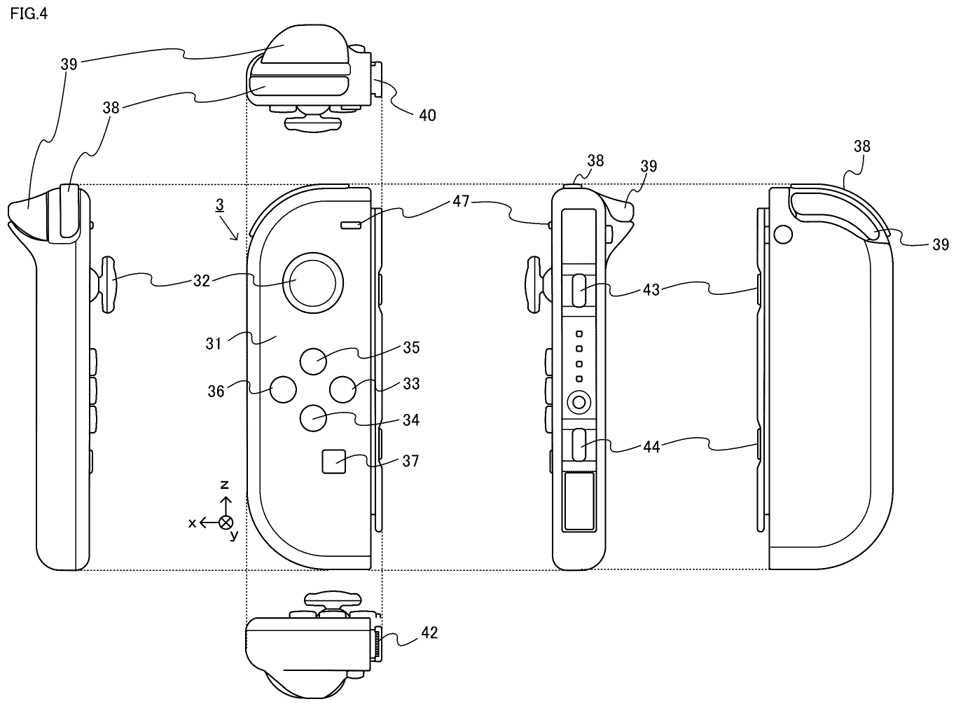

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction (a z-axis direction shown in FIG. 4) in FIG. 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly, the left hand. Further, the left controller 3 can also be held in the orientation in which the left controller 3 is horizontally long. When held in the orientation in which the left controller 3 is horizontally long, the left controller 3 may be held with both hands.

The left controller 3 includes a left analog stick (hereinafter, referred to as a “left stick”) 32, which is an example of a direction input device. As shown in FIG. 4, the left stick 32 is provided on a main surface of the housing 31. The left stick 32 can be used as a direction input section with which a direction can be inputted. The user tilts the left stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the left stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

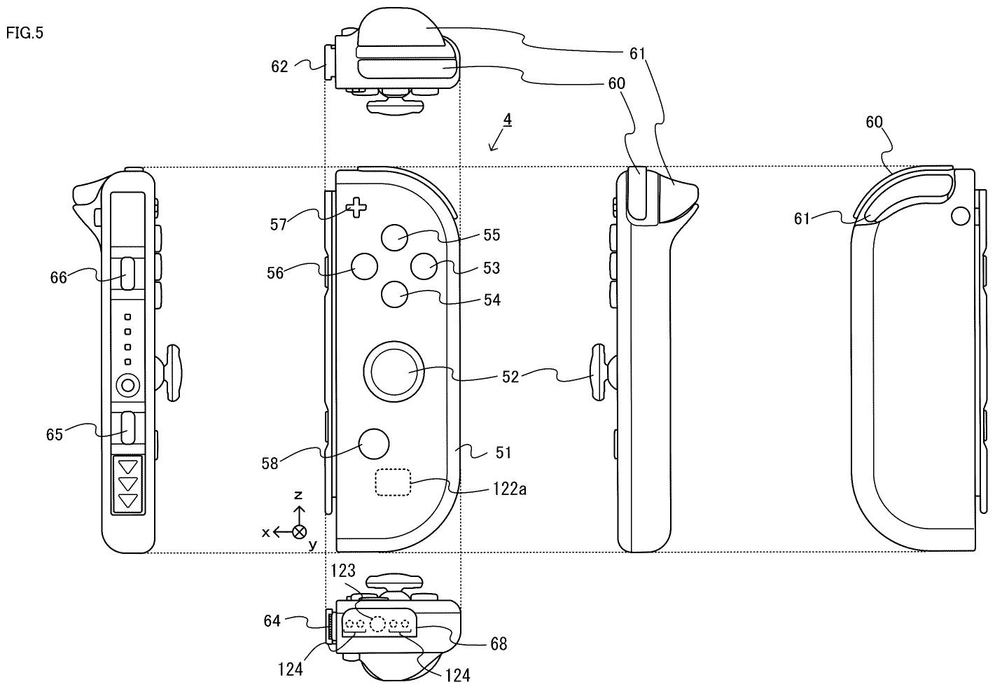

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction (the z-axis direction shown in FIG. 5) in FIG. 5. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly, the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes a right analog stick (hereinafter, referred to as a “right stick”) 52 as a direction input section. In the exemplary embodiment, the right stick 52 has the same configuration as that of the left stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, the network communication section 82 connects to a wireless LAN by a method compliant with the Wi-Fi standard, for example, and performs Internet communication or the like with an external apparatus (another main body apparatus 2). Further, the network communication section 82 can also perform short-range wireless communication (e.g., infrared light communication) with another main body apparatus 2.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is discretionary. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). On the basis of a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

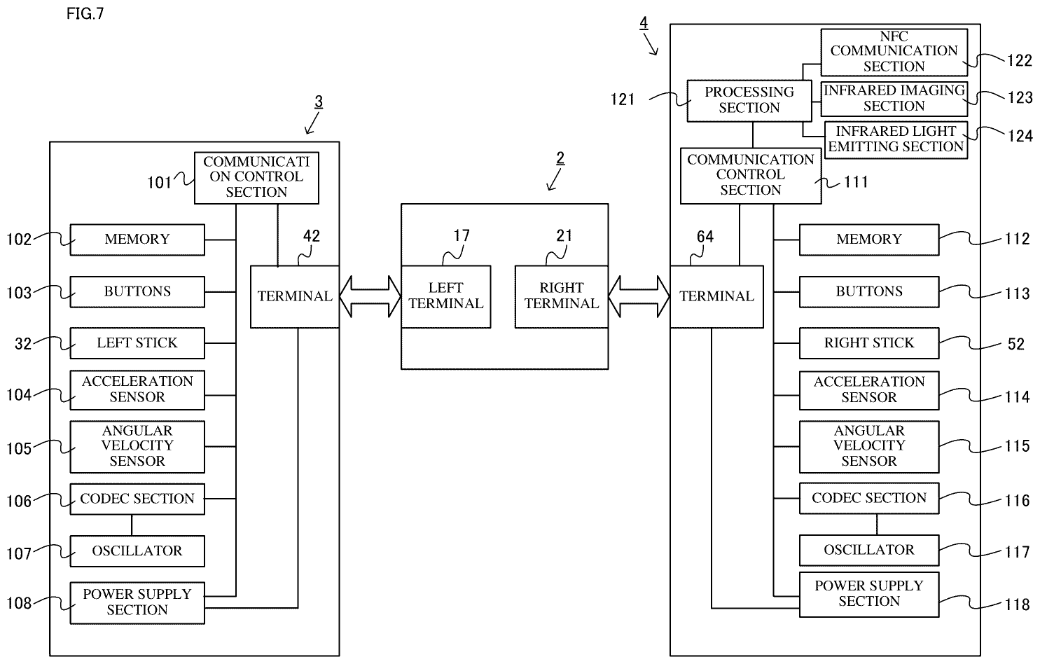

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104. Further, the left controller 3 includes an angular velocity sensor 105. In the exemplary embodiment, the acceleration sensor 104 detects the magnitudes of accelerations along predetermined three axial (e.g., xyz axes shown in FIG. 4) directions. It should be noted that the acceleration sensor 104 may detect an acceleration along one axial direction or accelerations along two axial directions. In the exemplary embodiment, the angular velocity sensor 105 detects angular velocities about predetermined three axes (e.g., the xyz axes shown in FIG. 4). It should be noted that the angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation, or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, the right stick 52, and inertial sensors (an acceleration sensor 114 and an angular velocity sensor 115). These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### Game Assumed in Exemplary Embodiment

Next, an outline of game processing (an example of the information processing) executed in the game system 1 according to the exemplary embodiment will be described. A game assumed in the exemplary embodiment is, for example, an action game in which a player object (sometimes referred to as “player character” or “PO”) which performs actions in accordance with operations performed by a player (user) moves and performs other actions in a virtual space (game space) in which various objects are placed, to achieve a predetermined objective (objective to reach a goal point). This game is not limited thereto, and may be other types of games.

### Outline of Game Processing of Exemplary Embodiment

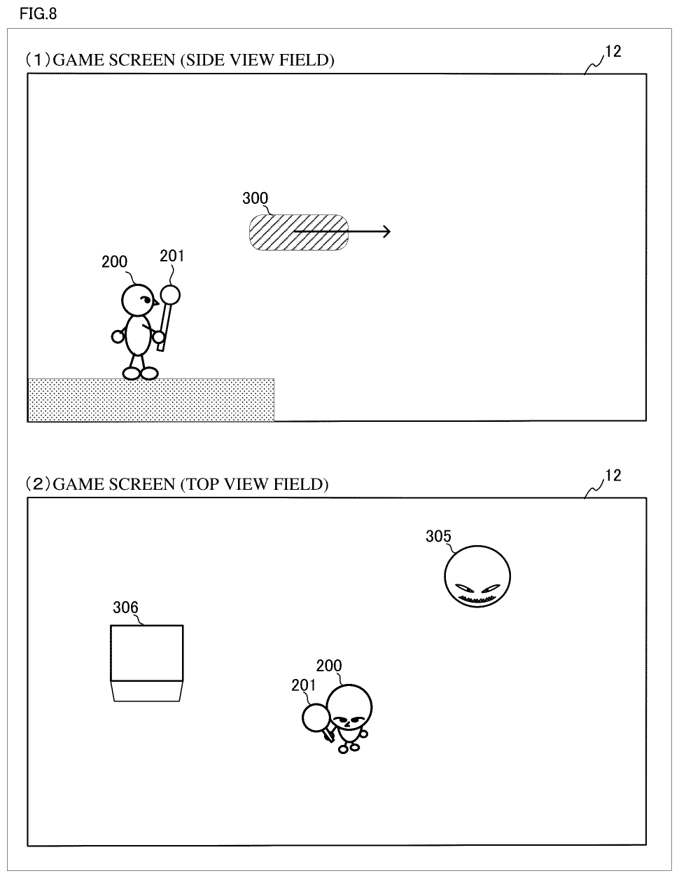

FIG. 8 illustrates a game screen of this game. In this game processing, the game is advanced by controlling the actions, etc., of many objects placed on a field in the virtual space, taking (rendering) an image of the field by a virtual camera, and displaying the image on a screen (the display 12 or the like).

The game scene of this game includes a game scene in which a scene of a side view field is displayed as illustrated in FIG. 8 (1) and a game scene in which a scene of a top view field is displayed as illustrated in FIG. 8 (2). The side view field is a field in a scene where the virtual camera is set to side view in horizontal orientation, and the top view field is a field in a scene where the virtual camera is set to top view in which the virtual camera looks down from above or diagonally from above. In addition, a game scene in which a quarter view field in a scene where the virtual camera is set to quarter view may also be included.

As shown in FIGS. 8 (1) and (2), a PO 200 has a magic wand object (sometimes referred to simply as “wand”) 201. In addition, various objects such as enemy objects, moving platform objects, block objects, rock objects, tree objects, ground objects, wall objects (sometimes simply referred to as “enemies”, “moving platforms”, “blocks”, “rocks”, “trees”, “grounds”, and “walls”) appear in this game. These objects include “dynamic objects”. Dynamic objects are automatically controlled to move based on predetermined behavior. For example, a moving platform 300 is a dynamic object, and as shown in FIG. 8 (1), the moving platform 300 floats in the air at a certain height and moves straight at a certain speed. The moving platform 300 may move in other ways. In addition, for example, an enemy 305 (see FIG. 8 (2)) is a dynamic object, and attacks the PO 200 by moving, etc., by itself. Moreover, for example, a block 306 (see FIG. 8 (2)) and a rock (not shown) are dynamic objects and do not move, etc., by themselves, but behavior of moving due to application of an external force from the enemy 305, the PO 200, or the like may be set therefor.

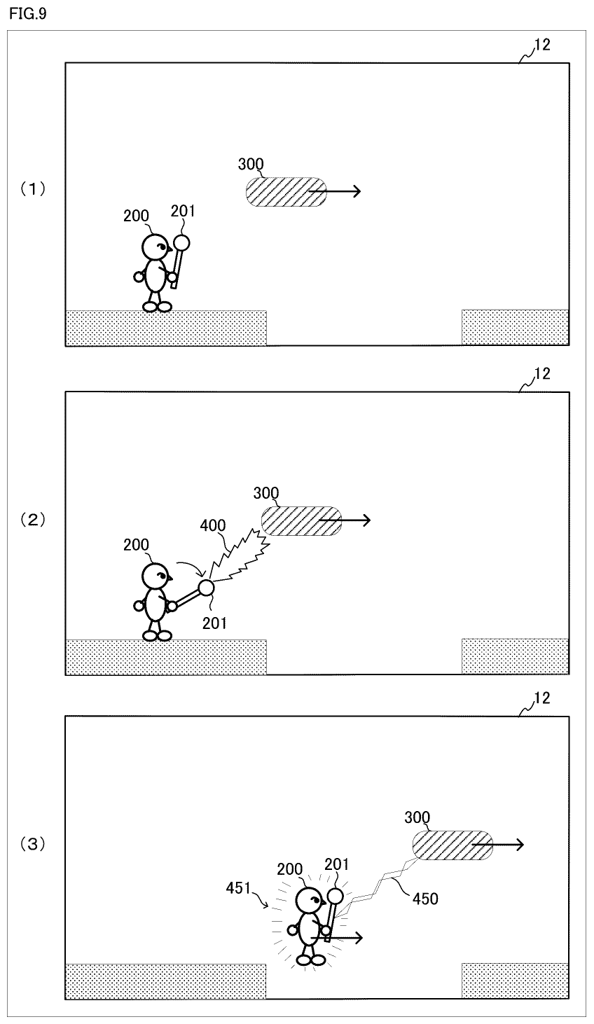

FIG. 9 to FIG. 15 show examples of a game image in the side view scene of this game, and are diagrams for describing the interaction between the PO 200 and a dynamic object. As shown in FIG. 9 (1), the moving platform 300 is automatically moving straight in a direction in which the PO 200 moves forward. Also, there is a large hole in the direction in which the PO 200 moves forward, and if the PO 200 moves forward as it is, the PO 200 will fall into the hole. As an example, the PO 200 moves or changes its direction in response to the left stick 32 being operated.

In the exemplary embodiment, as an example, a dynamic object closest to the PO 200 among the dynamic objects located within a predetermined distance in front of the PO 200 is automatically set as a dynamic object that is a lock-on target. Then, when a predetermined button (e.g., the ZL-button 39) is pressed, a dynamic object set as a lock-on target is locked on. When the currently locked-on dynamic object moves, the PO 200 changes its direction so as to face in a direction toward the moving dynamic object. In FIG. 9 (1), the moving platform 300 is locked on. The lock-on is cancelled when the predetermined button is pressed again.

Next, as shown in FIG. 9 (2), when a predetermined button (e.g., the X-button 55) is pressed, the PO 200 performs an action of swinging down the wand 201, and an emission object 400 is emitted from the wand 201 toward the front of the PO 200, regardless of whether or not any dynamic object is locked on. In FIG. 9 (2), since the moving platform 300 is locked on, the emission object 400 is emitted from the wand 201 toward the currently locked-on moving platform 300. Next, as shown in FIG. 9 (3), the emission object 400 hits the moving platform 300, the moving platform 300 is designated as a moving object to be interlocked with the PO 200, and the PO 200 and the moving platform 300 begin to be interlocked. During the interlock, an interlocking effect 450 is displayed between the PO 200 and the moving platform 300. Also, as shown in FIG. 9 (3), the PO 200 automatically moves in response to the movement of the moving platform 300 which is the interlock partner. In FIG. 9 (3), the PO 200 is automatically moving in response to the movement of the moving platform 300 and is moving through the air without falling into the hole.

In FIG. 9 (3), the moving platform 300 is the interlock source, and the PO 200 is automatically moving in response to the movement of the moving platform 300 which is the interlock source. As will be described later, the interlock source is switched between the PO 200 and the dynamic object in response to an operation input. In addition, a dependent effect 451 is displayed around the object moving in response to the movement of the object that is the interlock source. Thus, in FIG. 9 (3), the dependent effect 451 is displayed around the PO 200.

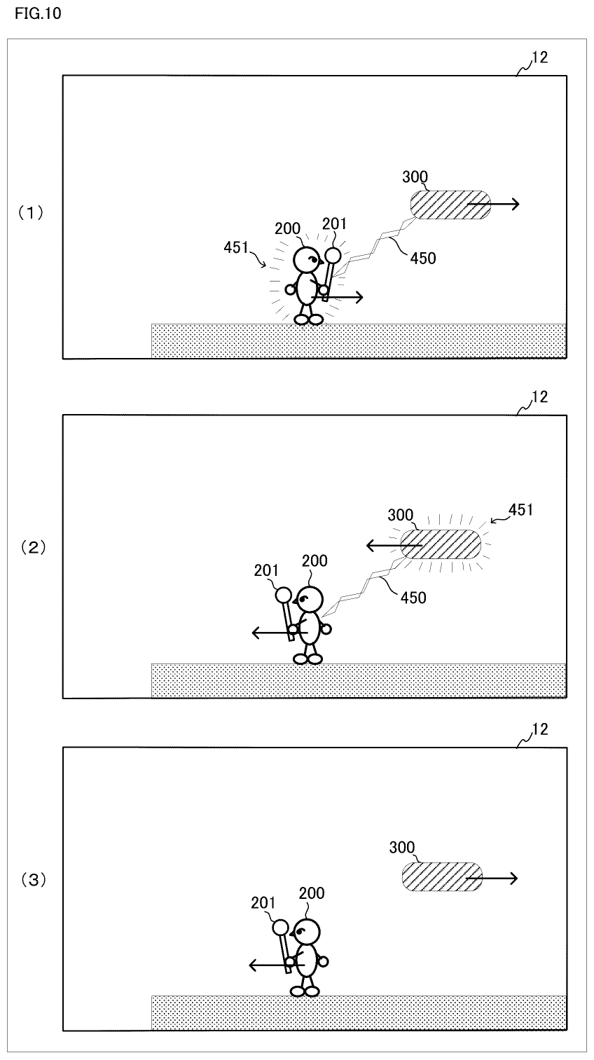

Next, as shown in FIG. 10 (1), while the PO 200 is automatically moving in response to the movement of the moving platform 300 which is the interlock source as in FIG. 9 (3), when a predetermined button (e.g., the first R-button 60) is pressed, the interlock source is switched from the moving platform 300 to the PO 200. Then, as shown in FIG. 10 (2), the moving platform 300 moves (stopping its automatic movement) in response to the movement of the PO 200 which is the interlock source (movement in response to an operation by the player). In FIG. 10 (2), the moving platform 300 is moving backward (stopping its automatic movement in the forward direction) in response to the movement (backward movement) of the PO 200 made in response to an operation by the player. Each time the predetermined button (e.g., the first R-button 60) is pressed, the interlock source is switched.

Then, as shown in FIG. 10 (3), when a predetermined button (e.g., the ZR-button 61) is pressed while the PO 200 and the dynamic object are interlocked with each other, the interlock is cancelled. In FIG. 10 (3), the interlock (designation) is cancelled, the PO 200 is moving in response to an operation by the player, and the moving platform 300 is automatically moving based on predetermined behavior.

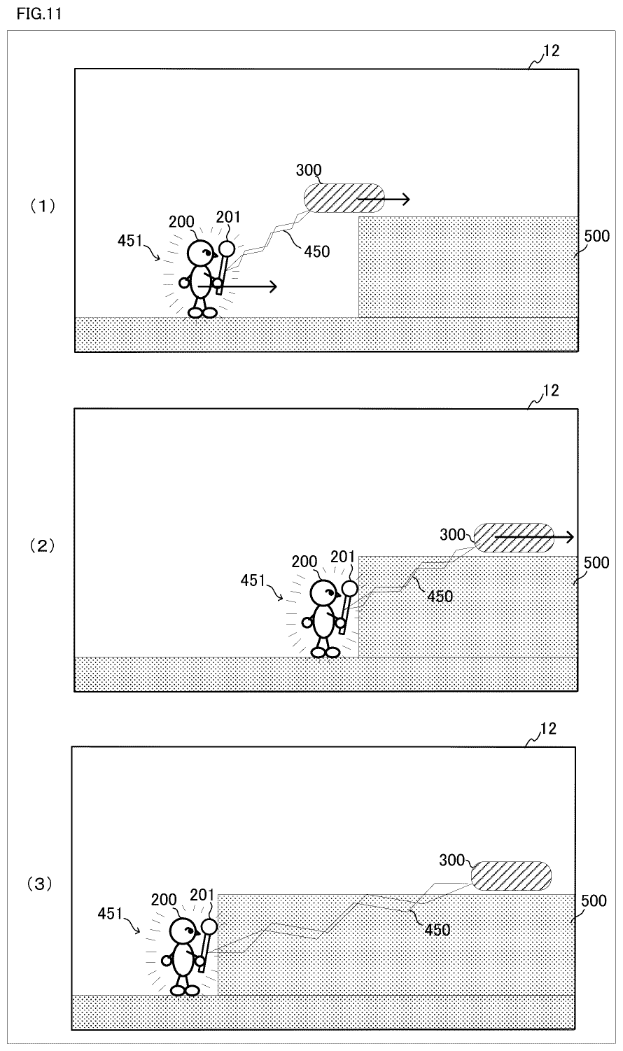

In addition, as shown in FIG. 9 (3) and FIGS. 10 (1) and (2), the currently interlocked PO 200 and dynamic object move such that the relative positional relationship therebetween is maintained, except in the cases described later with reference to FIG. 11, etc.

Next, the case where, as shown in FIG. 11 (1), a wall 500 is placed at the movement destination of the PO 200 when the PO 200 is automatically moving in response to the movement of the moving platform 300 which is the interlock source as in FIG. 10 (1), will be described. In this case, since no object can enter the interior of the wall 500, the PO 200 stops at the position where the PO 200 contacts with the wall 500, and the moving platform 300 continues to move forward, as shown in FIG. 11 (2). Then, as shown in FIG. 11 (3), when the distance between the PO 200 and the moving platform 300 reaches a predetermined distance, the moving platform 300 cannot move any further in the direction away from the PO 200 and stops. The predetermined distance is, for example, 6 m (assuming that the height of the PO 200 is 1.5 m) in the virtual space. In addition, the relative positional relationship between the PO 200 and the moving platform 300 is updated and changed (see FIGS. 11 (1) to (3)). Then, for example, when the PO 200 goes up onto the wall 500 in response to an operation by the player, the PO 200 automatically moves again in response to the movement of the moving platform 300 which is the interlock source (not shown). Walls are an example of objects that define locations that cannot be entered, and such objects may be other objects. In addition, an area that cannot be entered may be set without placing any object.

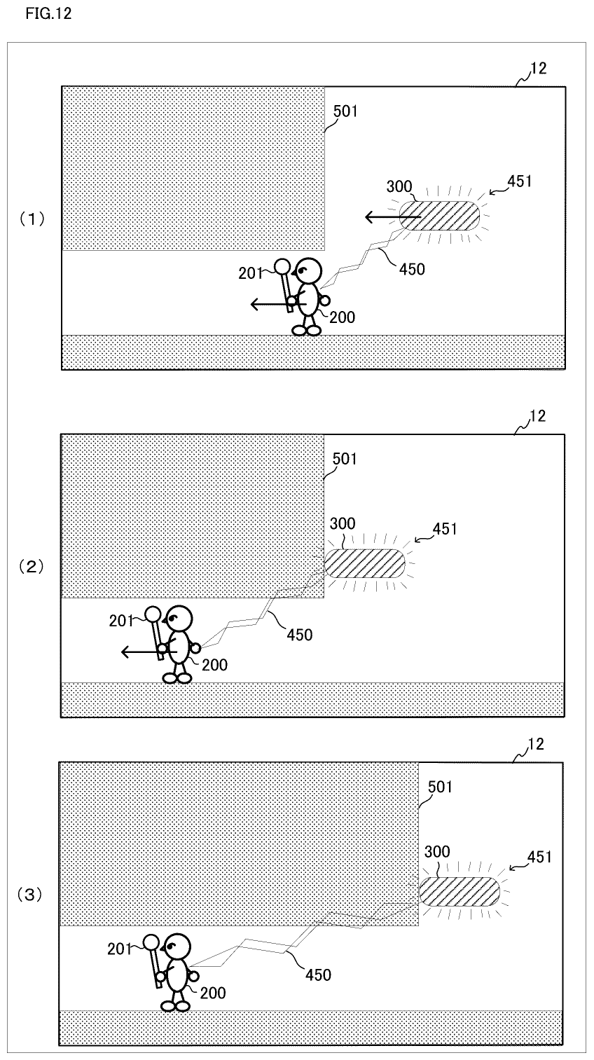

Next, the case where, as shown in FIG. 12 (1), a wall 501 is placed at the movement destination of the moving platform 300 when the moving platform 300 is moving in response to the movement of the PO 200 which is the interlock source as in FIG. 10 (2), will be described. In this case, since no object can enter the interior of the wall 501, the moving platform 300 stops at the position where the moving platform 300 contacts with the wall 501, and the PO 200 continues to move forward in response to an operation by the player, as shown in FIG. 12 (2). Then, as shown in FIG. 12 (3), when the distance between the PO 200 and the moving platform 300 reaches the predetermined distance, the PO 200 cannot move any further in the direction away from the moving platform 300 even if an operation is performed by the player. In addition, the relative positional relationship between the PO 200 and the moving platform 300 is updated and changed (see FIGS. 12 (1) to (3)).

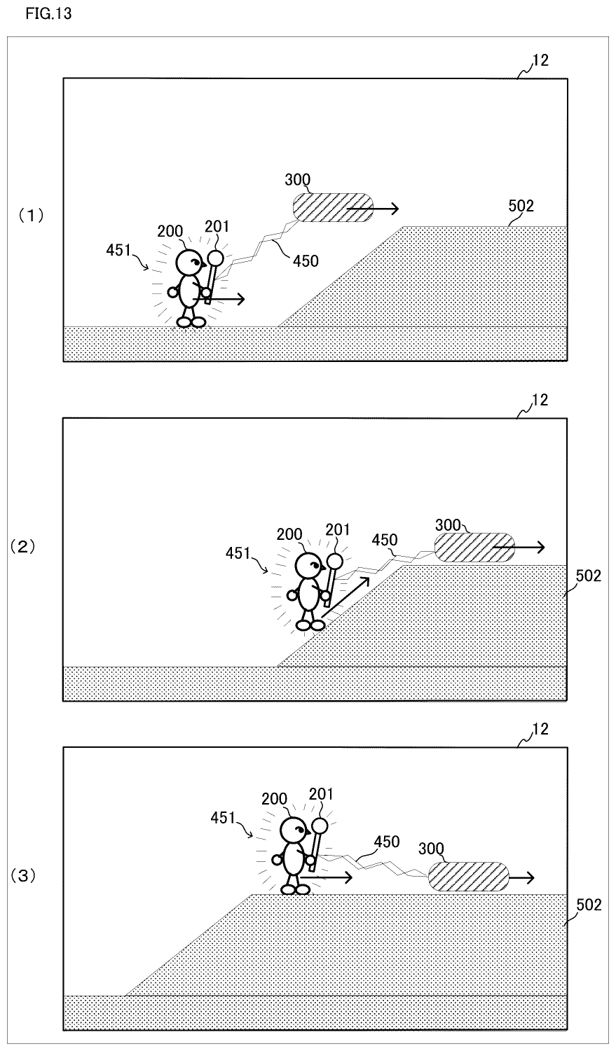

Next, the case where, as shown in FIG. 13 (1), a wall 502 having a slope is placed at the movement destination of the PO 200 when the PO 200 is automatically moving in response to the movement of the moving platform 300 which is the interlock source as in FIG. 10 (1), will be described. In this case, since no object can enter the interior of the wall 502, the PO 200 moves along the slope of the wall 502 as if being pulled by the moving platform 300 as shown in FIG. 13 (2). Then, the PO 200 moves onto the upper surface of the wall 502, and then moves on the upper surface of the wall 502 in response to the movement of the moving platform 300 as shown in FIG. 13 (3). In addition, the relative positional relationship between the PO 200 and the moving platform 300 is updated and changed (see FIGS. 13 (1) to (3)).

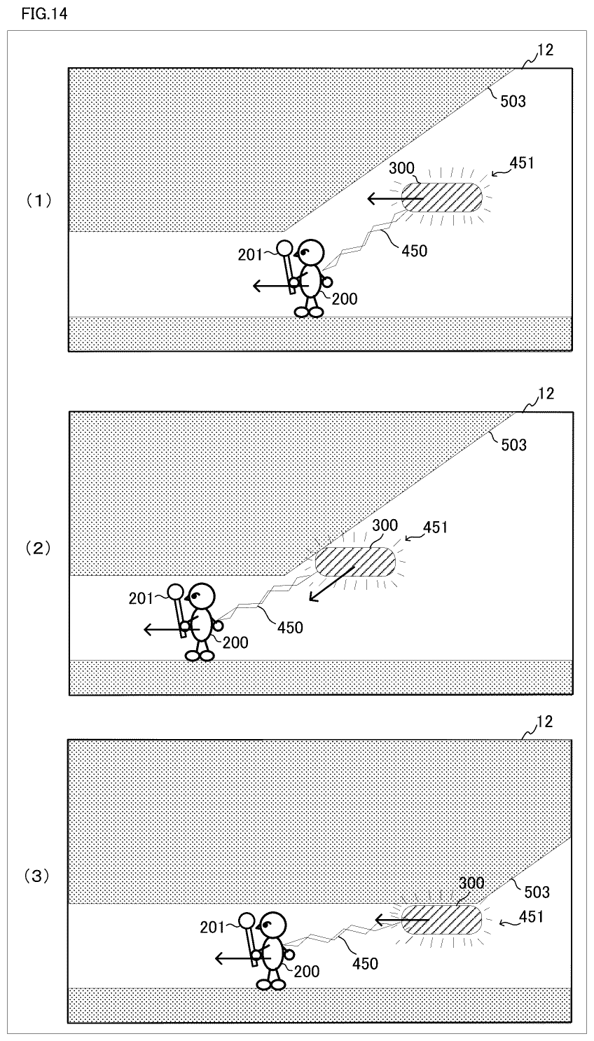

Next, the case where, as shown in FIG. 14 (1), a wall 503 having a slope is placed at the movement destination of the moving platform 300 when the moving platform 300 is moving in response to the movement of the PO 200 which is the interlock source as in FIG. 10 (2), will be described. In this case, since no object can enter the interior of the wall 503, the moving platform 300 moves along the slope of the wall 503, descending as if being pulled by the PO 200 moving in response to an operation by the player, as shown in FIG. 14 (2). Then, the moving platform 300 moves onto the lower surface of the wall 503, and then moves on the lower surface of the wall 502 in response to the movement of the PO 200 as shown in FIG. 14 (3). In addition, the relative positional relationship between the PO 200 and the moving platform 300 is updated and changed (see FIGS. 14 (1) to (3)).

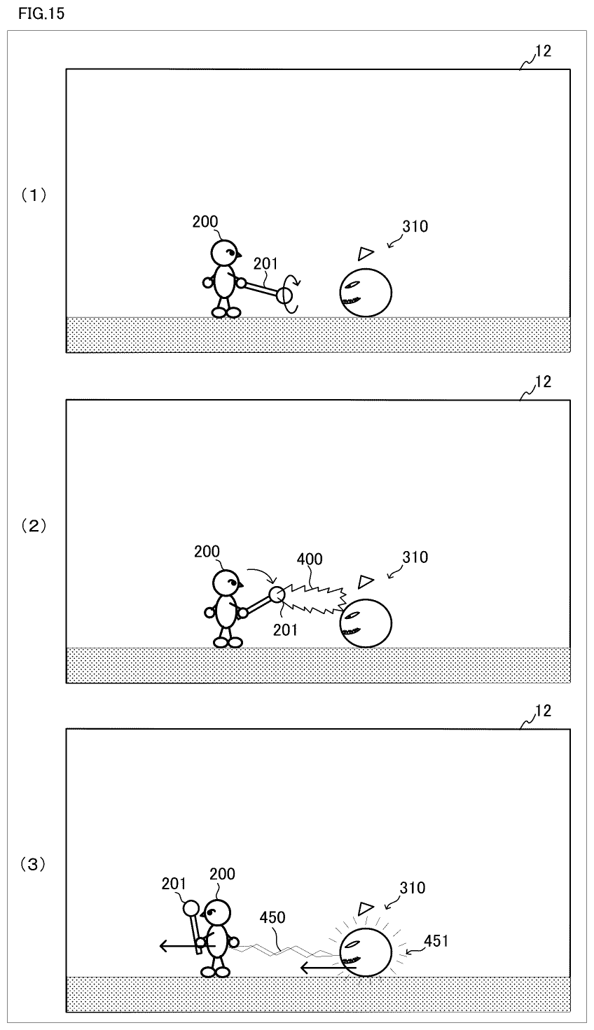

Next, as shown in FIG. 15 (1), when a predetermined button (e.g., the Y-button 56) is pressed, the PO 200 performs an action of moving the tip of the wand 201 so as to draw a circle, and a “simulated object” appears on the field. In FIG. 15 (1), a simulated object (sometimes referred to as “simulated enemy”) 310 for the enemy 305 (see FIG. 8 (2)) appears. The simulated object is a dynamic object caused to appear on the field by the PO 200, and shares at least part of appearance and behavior (predetermined behavior) with an existing dynamic object placed on the field (dynamic object placed on the field without being caused to appear on the field by the PO 200). For example, a triangular plate-shaped object is added above the simulated object such that this object can be identified as a simulated object (see FIG. 15). The simulated enemy 310 moves, etc. by itself like the enemy 305, and does not attack the PO 200 but attacks enemies for the PO 200, unlike the enemy 305. The PO 200 can also cause a simulated object for the block 306, a simulated object for the rock, etc., to appear on the field. The simulated object for the block 306 and the simulated object for the rock are the same as the block 306 and the rock, except that, for example, a triangular plate-shaped object is added above each simulated object such that this object can be identified as a simulated object.

Next, as shown in FIG. 15 (2), when a predetermined button (e.g., the X-button 55) is pressed, the PO 200 performs an action of swinging down the wand 201, and the emission object 400 is emitted from the wand 201 toward the simulated enemy 310. Next, as shown in FIG. 15 (3), the emission object 400 hits the simulated enemy 310, the simulated enemy 310 is designated as a moving object to be interlocked with the PO 200, and the PO 200 and the simulated enemy 310 begin to be interlocked. In FIG. 15 (3), the simulated enemy 310 is moving in response to the movement of the PO 200 which is the interlock source.

The PO 200 can be interlocked with all dynamic objects including enemies. Even when the PO 200 and an enemy are interlocked, the PO 200 can attack the enemy, and the enemy can attack the PO 200. In addition, when the PO 200 and a block or a rock (dynamic object that does not move, etc., by itself) are interlocked, the block or the rock can be moved in response to the PO 200 moving in response to an operation by the player.

In the above, the examples in which the PO 200 and the moving platform 300 are interlocked have been described with reference to FIG. 9 to FIG. 14. However, the same control is also performed when the PO 200 and the enemy 305 or the simulated enemy 310 are interlocked. That is, control is performed such that, for example, an object that is the interlock partner moves in response to the movement of an object that is the interlock source.

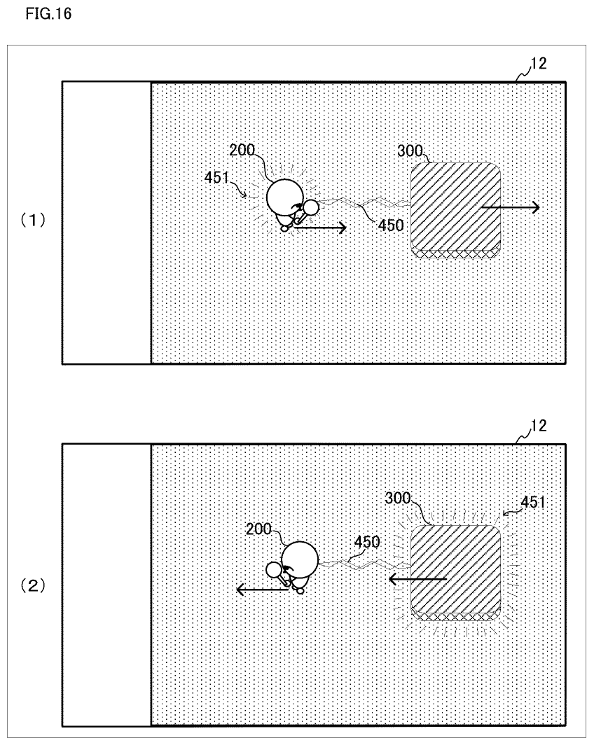

The above description has been given using the scenes of the side view field (see FIG. 9 to FIG. 15), but the same control is also performed in scenes of the top view field. Hereinafter, some examples of scenes of the top view field will be briefly described with reference to the drawings. FIG. 16 to FIG. 18 illustrate cases of scenes of the top view field. For convenience of description, a description is sometimes given below using diagrams of scenes of the top view field corresponding to the same field examples as the examples of the scenes of the side view field described above.

FIG. 16 (1) is a diagram of the top view field corresponding to the same field example as the example of the scene of the side view field in FIG. 10 (1), and FIG. 16 (2) is a diagram of the top view field corresponding to the same field example as the example of the scene of the side view field in FIG. 10 (2). As shown in FIG. 16 (1), in the top view field, the PO 200 is automatically moving in response to the movement of the moving platform 300 which is the interlock source. As shown in FIG. 16 (2), in the top view field, the moving platform 300 is moving in response to the movement of the PO 200, which is the interlock source, made in response to an operation by the player.

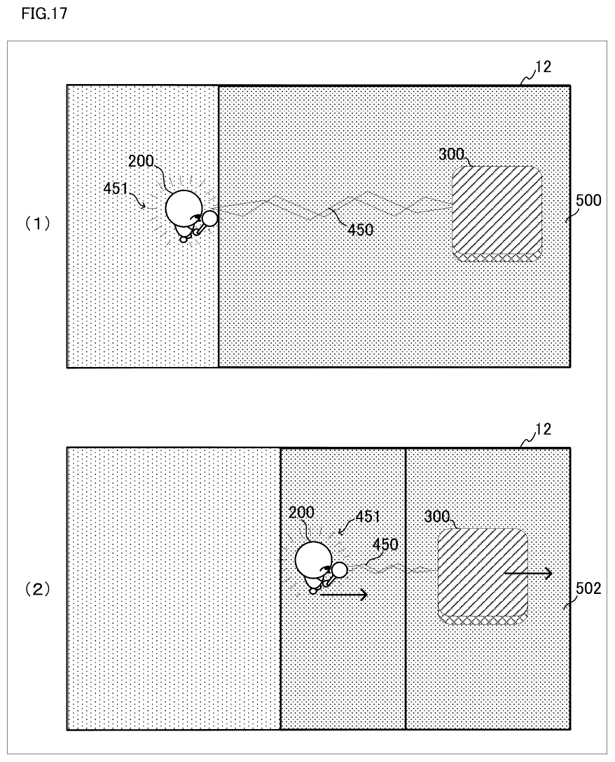

FIG. 17 (1) is a diagram of the top view field corresponding to the same field example as the example of the scene of the side view field in FIG. 11 (3), and FIG. 17 (2) is a diagram of the top view field corresponding to the same field example as the example of the scene of the side view field in FIG. 13 (2). In the top view field, the PO 200 automatically moving forward in response to the movement of the moving platform 300, which is the interlock source, stops at the position where the PO 200 contacts with the wall 500 (not shown; see FIG. 11 (2)), and then, as shown in FIG. 17 (1), when the distance between the PO 200 and the moving platform 300 reaches the predetermined distance, the moving platform 300 cannot move any further in the direction away from the PO 200 and stops. In addition, as shown in FIG. 17 (2), in the top view field, the PO 200 is moving along the upward slope of the wall 502, as if being pulled by the moving platform 300, in response to the movement of the moving platform 300 which is the interlock source.

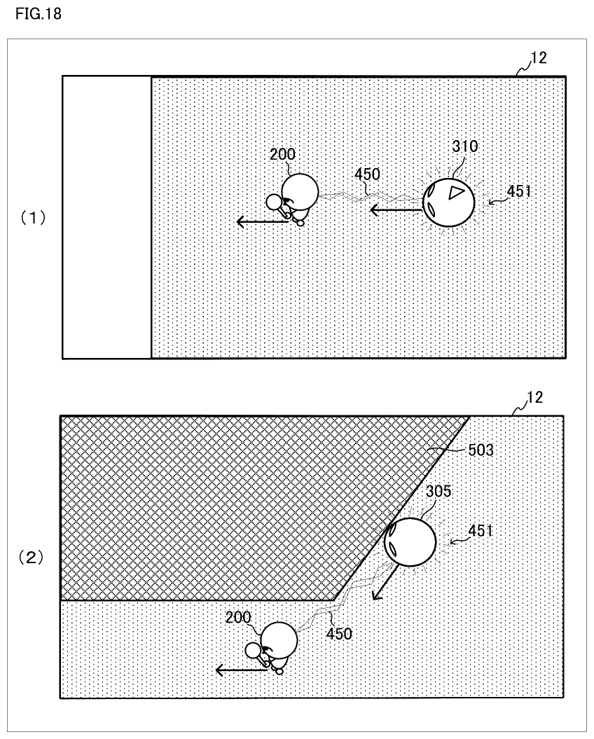

FIG. 18 (1) is a diagram of the top view field corresponding to the same field example as the example of the scene of the side view field in FIG. 15 (3). As shown in FIG. 18 (1), in the top view field, the simulated enemy 310 is moving in response to the movement of the PO 200, which is the interlock source, made in response to an operation by the player. FIG. 18 (2) shows the case where, in the top view field, the PO 200 and the enemy 305 are interlocked, and the enemy 305 is moving in response to the movement of the PO 200, which is the interlock source, made in response to an operation by the player. And, since no object can enter the interior of the wall 503, the enemy 305 is moving along an oblique wall surface of the wall 503 as if being pulled by the PO 200, in response to the movement of the PO 200 which is the interlock source, as shown in FIG. 18 (2).

In the above, some examples of control in scenes of the top view field have been specifically described with reference to FIG. 16 to FIG. 18, but, in the scenes of the top view field, control is performed with respect to the PO 200, dynamic objects, etc., in the same manner as in the scenes of the side view field.

### Details of Information Processing of Exemplary Embodiment

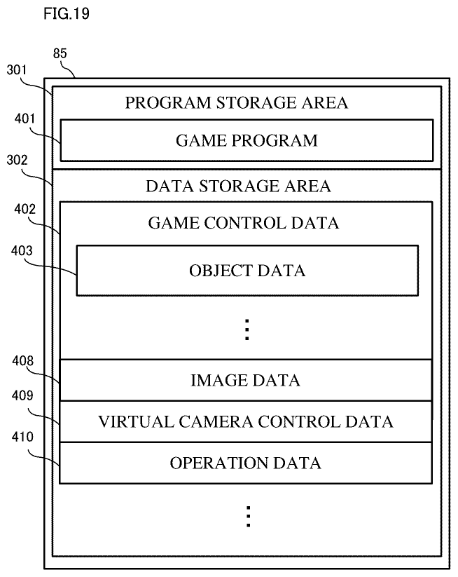

Next, the information processing of the exemplary embodiment will be described in detail with reference to FIGS. 19 to 21.

### Data to be Used

Various types of data used in the game processing will be described. FIG. 19 shows an example of data stored in the DRAM 85 of the game system 1. As shown in FIG. 19, the DRAM 85 is provided with at least a program storage area 301 and a data storage area 302. A game program 401 is stored in the program storage area 301. In the data storage area 302, game control data 402, image data 408, virtual camera control data 409, operation data 410, etc., are stored. The game control data 402 includes object data 403.

The game program 401 is a game program for executing the game processing.

The object data 403 is data of objects to be placed in the virtual space, such as player characters, enemy characters, blocks, items, grounds, rocks, stones, trees, and buildings. In addition, the object data 403 includes data of the coordinates, the orientation, the posture, the state, etc., of each object.

The image data 408 is image data of backgrounds, virtual effects, etc.

The virtual camera control data 409 is data for controlling the motion of the virtual camera placed in the virtual space. Specifically, the virtual camera control data 409 is data that specifies the position/orientation, angle of view, imaging direction, etc., of the virtual camera.

The operation data 410 is data indicating the contents of operations performed on the left controller 3 and the right controller 4.

In addition, various types of data to be used in game processing are stored as necessary in the DRAM 85.

### Details of Game Processing

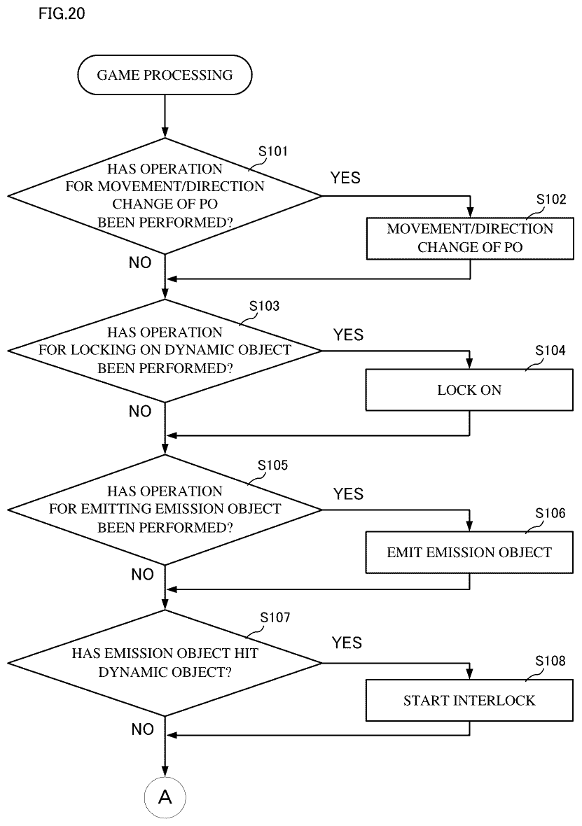

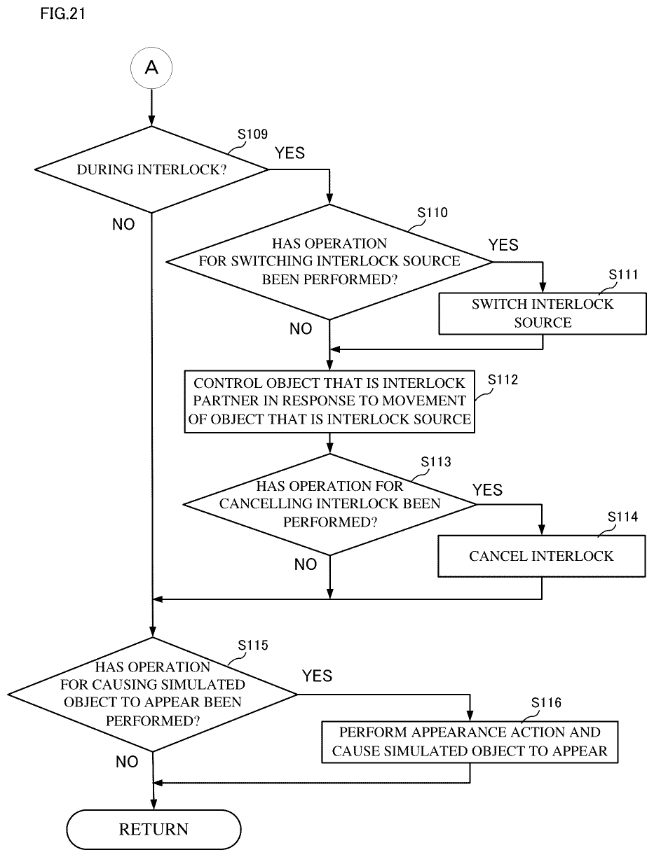

Next, the game processing according to the exemplary embodiment will be described in detail with reference to flowcharts. FIG. 20 and FIG. 21 are each an example of a flowchart showing the details of the game processing according to the exemplary embodiment. Hereinafter, the processing that is characteristic of the exemplary embodiment will be mainly described, and the description of other processing such as rendering is omitted.

When this game is started, the game processing in FIG. 20 and FIG. 21 is started. When a predetermined game end condition is satisfied and this game ends, the game processing ends.

First, in step S101 in FIG. 20, the processor 81 determines whether or not an operation for moving the PO 200 or changing the direction of the PO 200 has been performed, on the basis of the operation data 410. If the result of this determination is YES, the processing shifts to step S102, and if the result of this determination is NO, the processing shifts to step S103.

In step S102, the processor 81 moves the PO 200 or changes the direction of the PO 200 on the basis of the operation determined in step S101. Then, the processing shifts to step S103. The processor 81 controls each dynamic object in the virtual space with preset behavior.

In step S103, the processor 81 determines whether or not an operation for locking on a dynamic object as described with reference to FIG. 9 (1) has been performed, on the basis of the operation data 410. If the result of this determination is YES, the processing shifts to step S104, and if the result of this determination is NO, the processing shifts to step S105.

In step S104, the processor 81 locks on the dynamic object that is the lock-on target determined in step S103. Then, the processing shifts to step S105.

In step S105, the processor 81 determines whether or not an operation for emitting the emission object 400 as described with reference to FIG. 9 (2) has been performed, on the basis of the operation data 410. If the result of this determination is YES, the processing shifts to step S106, and if the result of this determination is NO, the processing shifts to step S107.

In step S106, the processor 81 emits the emission object 400 (see FIG. 9 (2)). Then, the processing shifts to step S107.

In step S107, the processor 81 determines whether or not the emission object 400 has hit a dynamic object, on the basis of the object data 403. If the result of this determination is YES, the processing shifts to step S108, and if the result of this determination is NO, the processing shifts to step S109 in FIG. 21.

In step S108, the processor 81 starts interlocking between the PO 200 and the dynamic object (see FIG. 9 (3)). Then, the processing shifts to step S109 in FIG. 21.

In step S109 in FIG. 21, the processor 81 determines whether or not any dynamic object and the PO 200 are currently interlocked, on the basis of the object data 403. If the result of this determination is YES, the processing shifts to step S110, and if the result of this determination is NO, the processing shifts to step S115.

In step S110, the processor 81 determines whether or not an operation for switching the object that is the interlock source as described with reference to FIGS. 10 (1) and (2) has been performed, on the basis of the operation data 410. If the result of this determination is YES, the processing shifts to step S111, and if the result of this determination is NO, the processing shifts to step S112.

In step S111, the processor 81 switches the object that is the interlock source (see FIGS. 10 (1) and (2)). Then, the processing shifts to step S112.

In step S112, the processor 81 controls the object that is the interlock partner in response to the movement of the object that is the interlock source as described with reference to FIG. 9 to FIG. 18. Then, the processing shifts to step S113.

In step S113, the processor 81 determines whether or not an operation for cancelling the interlock of the objects as described with reference to FIG. 10 (3) has been performed, on the basis of the operation data 410. If the result of this determination is YES, the processing shifts to step S114, and if the result of this determination is NO, the processing shifts to step S115.

In step S114, the processor 81 cancels the interlock of the objects (see FIG. 10 (3)). Then, the processing shifts to step S115.

In step S115, the processor 81 determines whether or not an operation for causing a simulated object to appear as described with reference to FIG. 15 (1) has been performed, on the basis of the operation data 410. If the result of this determination is YES, the processing shifts to step S116, and if the result of this determination is NO, the processing returns to step S101 in FIG. 20.

In step S116, the processor 81 causes the PO 200 to perform an action for causing a simulated object to appear, and causes the simulated object to appear (see FIG. 15 (1)). Then, the processing returns to step S101 in FIG. 20.

In the above processing, when the PO 200 is controlled to move in conjunction with the movement of the dynamic object (see FIG. 11 (1), etc.), the movement of the PO 200 in response to an operation input (step S102) is possible within the predetermined distance (maximum distance by which the dynamic object and the PO 200 can be separated) described with reference to FIG. 11 (3). In addition, while the dynamic object and the PO 200 are interlocked, control of locking on the dynamic object (step S104), control of emitting the emission object (step S106), and control of performing an action for causing a simulated object to appear and causing the simulated object to appear (step S116) are not performed.

As described above, in the exemplary embodiment, the PO 200 and the dynamic object can be interlocked, and in response to the movement of one of the objects, the other object can be moved (see FIG. 9, FIG. 10, etc.). This allows the PO 200 and the dynamic object to be moved in various movement ways. In addition, in the exemplary embodiment, the interlock source for the interlock between the PO 200 and the dynamic object can be switched (FIG. 10). This allows the PO 200 and the dynamic object to be moved in a greater variety of ways.

### Modifications

In the exemplary embodiment, a case in which a series of processes regarding the game processing are executed in a single game apparatus (main body apparatus 2) has been described. In another exemplary embodiment, the series of processes may be executed in an information processing system including a plurality of information processing apparatuses. For example, in an information processing system including a terminal-side apparatus and a server-side apparatus communicable with the terminal-side apparatus via a network, some of the series of processes above may be executed by the server-side apparatus. Further, in an information processing system including a terminal-side apparatus and a server-side apparatus communicable with the terminal-side apparatus via a network, major processes among the series of processes above may be executed by the server-side apparatus, and some of the processes may be executed in the terminal-side apparatus. Further, in the above information processing system, the system on the server side may be implemented by a plurality of information processing apparatuses, and processes that should be executed on the server side may be shared and executed by a plurality of information processing apparatuses. Further, a configuration of a so-called cloud gaming may be adopted. For example, a configuration may be adopted in which: the game apparatus (main body apparatus 2) sends operation data indicating operations performed by the user to a predetermined server; various game processes are executed in the server; and the execution result is streaming-distributed as a moving image/sound to the game apparatus (main body apparatus 2).

While the exemplary embodiment and the modifications have been described, the description thereof is in all aspects illustrative and not restrictive. It is to be understood that various other modifications and variations may be made to the exemplary embodiment and the modifications.

1. A non-transitory computer-readable storage medium having stored therein instructions that, when executed by a processor of an information processing apparatus, cause the information processing apparatus to:
control a player character to move in a virtual space, based on an operation input;
automatically control at least one dynamic object placed on a field in the virtual space, based on preset behavior;
designate any one of the dynamic objects in response to a first instruction based on an operation input, and while the designation is performed,
in a first state, perform a first interlock movement control of moving the designated dynamic object in conjunction with movement of the player character without at least automatic movement of the dynamic object in the behavior, and
in a second state, perform a second interlock movement control of moving the player character in conjunction with automatic movement of the designated dynamic object based on the behavior;
switch between the first state and the second state in response to a second instruction based on an operation input; and
cancel the designation in response to a third instruction based on an operation input.

2. The storage medium according to claim 1, wherein
the first interlock movement control is a control of moving the designated dynamic object to a position where a relative positional relationship between the player character and the designated dynamic object is maintained, and
the second interlock movement control is a control of moving the player character to a position where the relative positional relationship is maintained.

3. The storage medium according to claim 2, wherein the instructions further cause the information processing apparatus to, if a movement destination based on the relative positional relationship of the designated dynamic object in the first interlock movement control or the player character in the second interlock movement control is a position that cannot be entered on the field, update the relative positional relationship without movement to the movement destination.

4. The storage medium according to claim 1, wherein the instructions further cause the information processing apparatus to:
in response to a fourth instruction based on an operation input, cause the player character to perform a predetermined action, and cause a simulated object to appear on the field, the simulated object sharing at least part of appearance and the behavior with at least any one type of the dynamic object among a plurality of types of the dynamic objects; and
automatically control the simulated object as the dynamic object on the field.

5. The storage medium according to claim 1, wherein the instructions further cause the information processing apparatus to:
in response to the first instruction, cause the player character to perform an action of emitting an emission object, and if the emission object hits the dynamic object, perform the designation with respect to the dynamic object; and
in response to a fifth instruction based on an operation input, change a direction of the player character such that an emission direction of the emission object is toward any one of the dynamic objects on the field.

6. The storage medium according to claim 2, wherein
the field includes at least a top view field that is a field in a scene where a virtual camera is set to top view, and a side view field that is a field in a scene where the virtual camera is set to side view,
the preset behavior for the dynamic object is behavior in the top view field and the side view field, and
the relative positional relationship is a relative positional relationship in the top view field and the side view field.

7. A game processing system comprising a processor and a memory coupled thereto, the processor being configured to control the game processing system to at least:
control a player character to move in a virtual space, based on an operation input;
automatically control at least one dynamic object placed on a field in the virtual space, based on preset behavior;
designate any one of the dynamic objects in response to a first instruction based on an operation input, and while the designation is performed,
in a first state, perform a first interlock movement control of moving the designated dynamic object in conjunction with movement of the player character without at least automatic movement of the dynamic object in the behavior, and
in a second state, perform a second interlock movement control of moving the player character in conjunction with automatic movement of the designated dynamic object based on the behavior;
switch between the first state and the second state in response to a second instruction based on an operation input; and
cancel the designation in response to a third instruction based on an operation input.

8. The game processing system according to claim 7, wherein
the first interlock movement control is a control of moving the designated dynamic object to a position where a relative positional relationship between the player character and the designated dynamic object is maintained, and
the second interlock movement control is a control of moving the player character to a position where the relative positional relationship is maintained.

9. The game processing system according to claim 8, wherein the processor is further configured to control the game processing system to, if a movement destination based on the relative positional relationship of the designated dynamic object in the first interlock movement control or the player character in the second interlock movement control is a position that cannot be entered on the field, update the relative positional relationship without movement to the movement destination.

10. The game processing system according to claim 7, wherein the processor is further configured to control the game processing system to:
in response to a fourth instruction based on an operation input, cause the player character to perform a predetermined action, and cause a simulated object to appear on the field, the simulated object sharing at least part of appearance and the behavior with at least any one type of the dynamic object among a plurality of types of the dynamic objects; and
automatically control the simulated object as the dynamic object on the field.

11. The game processing system according to claim 7, wherein the processor is further configured to control the game processing system to:
in response to the first instruction, cause the player character to perform an action of emitting an emission object, and if the emission object hits the dynamic object, perform the designation with respect to the dynamic object; and
in response to a fifth instruction based on an operation input, change a direction of the player character such that an emission direction of the emission object is toward any one of the dynamic objects on the field.

12. The game processing system according to claim 8, wherein
the field includes at least a top view field that is a field in a scene where a virtual camera is set to top view, and a side view field that is a field in a scene where the virtual camera is set to side view,
the preset behavior for the dynamic object is behavior in the top view field and the side view field, and
the relative positional relationship is a relative positional relationship in the top view field and the side view field.

13. A game processing apparatus comprising a processor and a memory coupled thereto, the processor being configured to control the game processing apparatus to at least:
control a player character to move in a virtual space, based on an operation input;
automatically control at least one dynamic object placed on a field in the virtual space, based on preset behavior;
designate any one of the dynamic objects in response to a first instruction based on an operation input, and while the designation is performed,
in a first state, perform a first interlock movement control of moving the designated dynamic object in conjunction with movement of the player character without at least automatic movement of the dynamic object in the behavior, and
in a second state, perform a second interlock movement control of moving the player character in conjunction with automatic movement of the designated dynamic object based on the behavior;
switch between the first state and the second state in response to a second instruction based on an operation input; and
cancel the designation in response to a third instruction based on an operation input.

14. The game processing apparatus according to claim 13, wherein
the first interlock movement control is a control of moving the designated dynamic object to a position where a relative positional relationship between the player character and the designated dynamic object is maintained, and
the second interlock movement control is a control of moving the player character to a position where the relative positional relationship is maintained.

15. The game processing apparatus according to claim 14, wherein the processor is further configured to control the game processing apparatus to, if a movement destination based on the relative positional relationship of the designated dynamic object in the first interlock movement control or the player character in the second interlock movement control is a position that cannot be entered on the field, update the relative positional relationship without movement to the movement destination.

16. The game processing apparatus according to claim 13, wherein the processor is further configured to control the game processing apparatus to:
in response to a fourth instruction based on an operation input, cause the player character to perform a predetermined action, and cause a simulated object to appear on the field, the simulated object sharing at least part of appearance and the behavior with at least any one type of the dynamic object among a plurality of types of the dynamic objects; and
automatically control the simulated object as the dynamic object on the field.

17. The game processing apparatus according to claim 13, wherein the processor is further configured to control the game processing apparatus to:
in response to the first instruction, cause the player character to perform an action of emitting an emission object, and if the emission object hits the dynamic object, perform the designation with respect to the dynamic object; and
in response to a fifth instruction based on an operation input, change a direction of the player character such that an emission direction of the emission object is toward any one of the dynamic objects on the field.

18. The game processing apparatus according to claim 14, wherein
the field includes at least a top view field that is a field in a scene where a virtual camera is set to top view, and a side view field that is a field in a scene where the virtual camera is set to side view,
the preset behavior for the dynamic object is behavior in the top view field and the side view field, and
the relative positional relationship is a relative positional relationship in the top view field and the side view field.

19. A game processing method executed by a processor configured to control a game processing system, the game processing method causing the game processing system to:
control a player character to move in a virtual space, based on an operation input;
automatically control at least one dynamic object placed on a field in the virtual space, based on preset behavior;
designate any one of the dynamic objects in response to a first instruction based on an operation input, and while the designation is performed,
in a first state, perform a first interlock movement control of moving the designated dynamic object in conjunction with movement of the player character without at least automatic movement of the dynamic object in the behavior, and
in a second state, perform a second interlock movement control of moving the player character in conjunction with automatic movement of the designated dynamic object based on the behavior;
switch between the first state and the second state in response to a second instruction based on an operation input; and
cancel the designation in response to a third instruction based on an operation input.

20. The game processing method according to claim 19, wherein
the first interlock movement control is a control of moving the designated dynamic object to a position where a relative positional relationship between the player character and the designated dynamic object is maintained, and
the second interlock movement control is a control of moving the player character to a position where the relative positional relationship is maintained.

21. The game processing method according to claim 20, further causing the game processing system to, if a movement destination based on the relative positional relationship of the designated dynamic object in the first interlock movement control or the player character in the second interlock movement control is a position that cannot be entered on the field, update the relative positional relationship without movement to the movement destination.

22. The game processing method according to claim 19, further causing the game processing system to:
in response to a fourth instruction based on an operation input, cause the player character to perform a predetermined action, and cause a simulated object to appear on the field, the simulated object sharing at least part of appearance and the behavior with at least any one type of the dynamic object among a plurality of types of the dynamic objects; and
automatically control the simulated object as the dynamic object on the field.

23. The game processing method according to claim 19, further causing the game processing system to:
in response to the first instruction, cause the player character to perform an action of emitting an emission object, and if the emission object hits the dynamic object, perform the designation with respect to the dynamic object; and
in response to a fifth instruction based on an operation input, change a direction of the player character such that an emission direction of the emission object is toward any one of the dynamic objects on the field.

24. The game processing method according to claim 20, wherein
the field includes at least a top view field that is a field in a scene where a virtual camera is set to top view, and a side view field that is a field in a scene where the virtual camera is set to side view,
the preset behavior for the dynamic object is behavior in the top view field and the side view field, and
the relative positional relationship is a relative positional relationship in the top view field and the side view field.
